(19) United States
(12) Patent Application Publication
(10) Pub. No.: US 2006/0041726 A1
(43) Pub. Date: Feb. 23, 2006

(54) Mirrorpc computer backup system

(76) Inventor: Edmund G. Steubing, Amherst, NH (US)

Correspondence Address: STEUBING MCGUINNESS & MANARAS LLP, 125 NAGOG PARK, ACTON, MA, 01720, US

(21) Appl. No.: 10/868,281

(22) Filed: Jun. 15, 2004

(51) Int. Cl. G06F 12/00; G06F 12/14

(52) U.S. Cl. 711/162

(57) ABSTRACT

Backup software operates in a client server environment wherein the clients may be transiently connected to the network. All the backup software resides and executes on the server, therefore no client side software is required. The backup software uses a mirror file including the names of the clients and predetermined locations on each client from which data should be backed up. Further logic copies the files at the predetermined locations on the client devices to the server by referring to the mirror file to access the files to be copied. Incremental backups from the predetermined areas are also supported.

### FIELD OF THE INVENTION

The present invention relates generally to computer data backup systems and more particularly to a server based backup system for backing up data for transient devices.

### BACKGROUND OF THE INVENTION

Computer networks of today tend to include not only desktop computing devices that are permanently connected to the network, but also transient devices such as laptop computers that are constantly connected to and removed from the network. Furthermore, use of dynamic IP address provisioning software such as DHCP (Dynamic Host Configuration Protocol) may cause IP addresses of networked devices to change at least every time a device is removed and then re-connected to the network.

The data backup software packages available today for backing up PCs are designed primarily to work with permanently connected desktop machines. Backup software that does operate to backup laptops requires client side software to be loaded and managed on each machine that may be connected to the network, which is expensive in terms of cost and administrative time. The proliferation of transient devices and dynamic IP addressing calls for a more flexible backup system that is designed to back up transient devices without the need for client side software.

### SUMMARY OF THE INVENTION

In accordance with the invention, backup software is provided for operation in a client server environment wherein the clients may be transiently connected to the network. All the backup software resides and executes on the server. The backup software uses a mirror file including the name of each client device connected to the network and the name of a predetermined location on each client device from which data should be copied. Further logic copies the files at the predetermined locations on the client devices to the server by referring to the mirror file to access the files to be copied.

In accordance with an advantage of the invention, the backup software can include logic for ascertaining, for each predetermined location, whether data has been copied from the predetermined location before, and if data has been copied from the predetermined location before, only data that is new or has been updated is copied. If data has not been copied from the predetermined location before, all the data at the predetermined location is copied.

The innovative backup software is advantageous and convenient to use because no separate client software is required. Furthermore, transient devices, who connect and disconnect from the network and whose network addresses change, are transparently supported.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a schematic representation of a computer network including a server and client devices in which the principles of the invention may be incorporated.

FIG. 2 is a block diagram showing the various software modules included in the backup software of the invention FIG. 3 is a flow diagram representing the functionality of the Mirror software module.

FIG. 4 is a flow diagram representing the functionality of the PChost module.

### DETAILED DESCRIPTION OF EXEMPLARY EMBODIMENTS

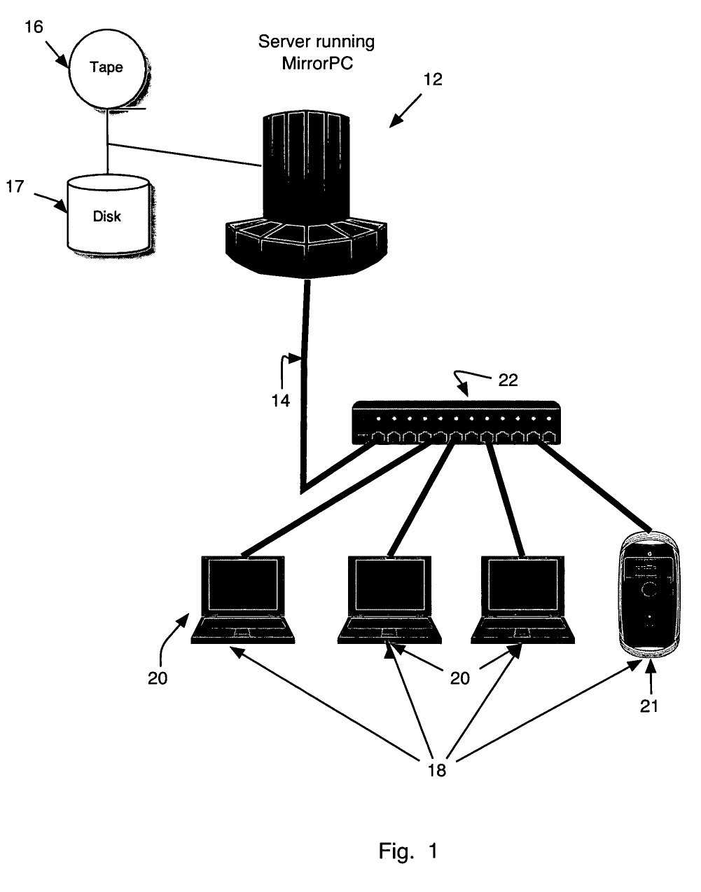

Referring to FIG. 1, there is shown an example of a computer intranet 10 employing the present invention. A server 12 is connected to a network 14. The server may be for example a Sun Microsystems E250, an NT server, or any other available type, and the invention is not limited by the server technology employed. The server 12 is coupled to a tape drive 16 and/or disk drive 17 for backup data. Also connected to the network 14 are client devices 18 including laptop computers 20 and a desktop computer 21, and could include other servers (not shown). The laptop and desktop computers may employ a Microsoft operating system such as XP, or may be Macintosh machines employing for example OS X. The invention is flexible in terms of the various types of client devices 18 that can be supported. The various devices are shown networked via an Ethernet switch 22; however, the network 14 could alternately be of the hub variety or could be based on another technology such as token ring or wireless LAN. The network 14 may also include clients at remote locations that connect to the network via, for example, a VPN. The invention is not limited by the network technology employed. A DHCP server, which may or may not reside in the server 12, dynamically assigns IP addresses to the client devices 18 as they connect and disconnect from the network 14.

In accordance with the principles of the invention, backup software 30 is executed by the server 12. The server 12 communicates with the client computers 18 through standard file sharing software, for example Samba. The server 12 uses the file sharing software to query any client devices 18 that may be connected to the network 14. The server 12 backup software is able to determine whether the state of data in designated folders on each client device 18 has changed, and if so, the server 12 backup software causes that data to be transferred over the network to the server 12. At a designated interval, such as once per day, all data transferred from each client device 18 to the server 12 is copied to the tape 16 or disk drive 17 for long term storage. The backup software is capable of keeping track of the IP addresses of client devices 18 as they change, to maintain continuity of the backup process. There is no need for special client side software to be loaded on the client devices 18 in order for the backup software 30 to function. Although not necessary for the backup function to operate, a user of a client device 18 is able to request an immediate full or incremental backup if desired.

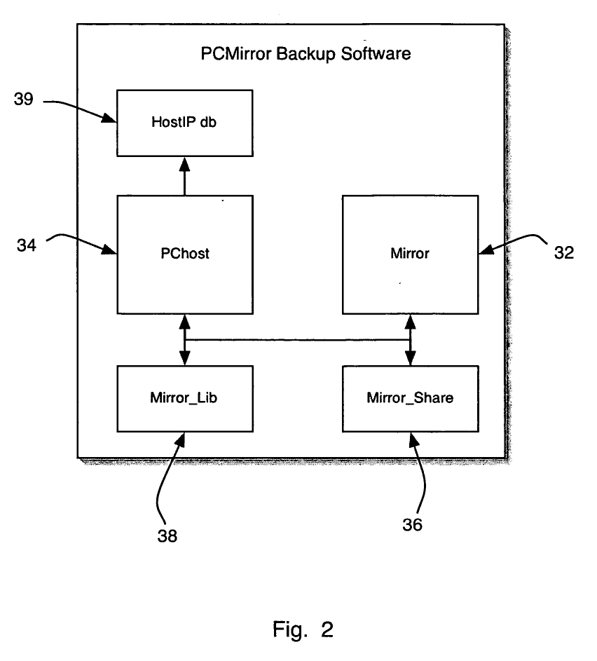

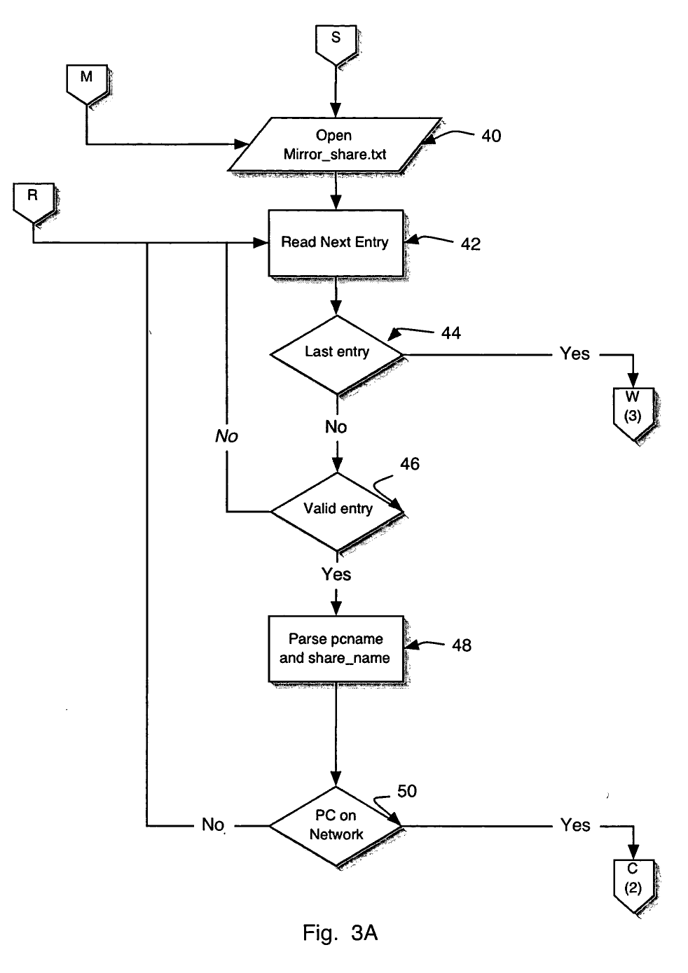

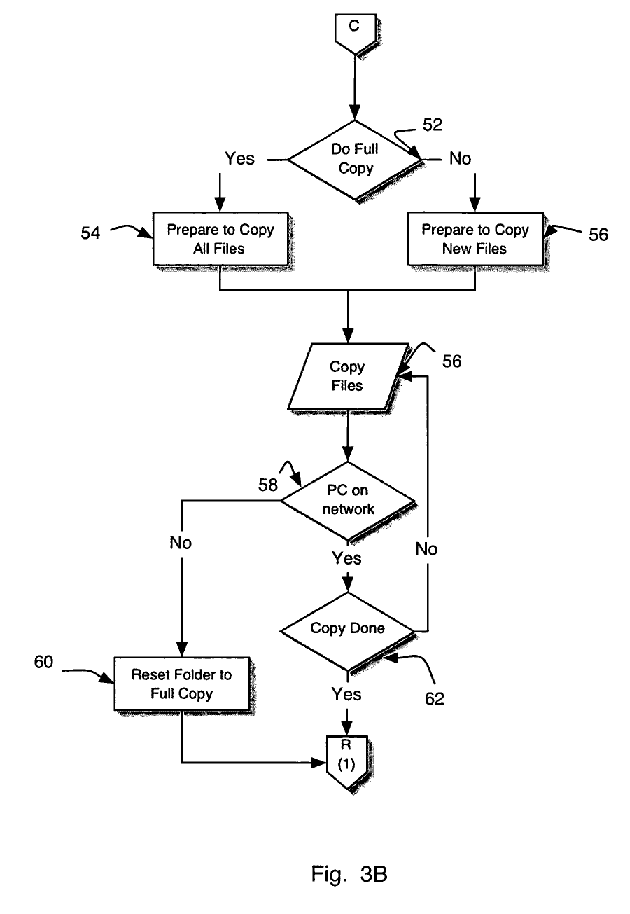

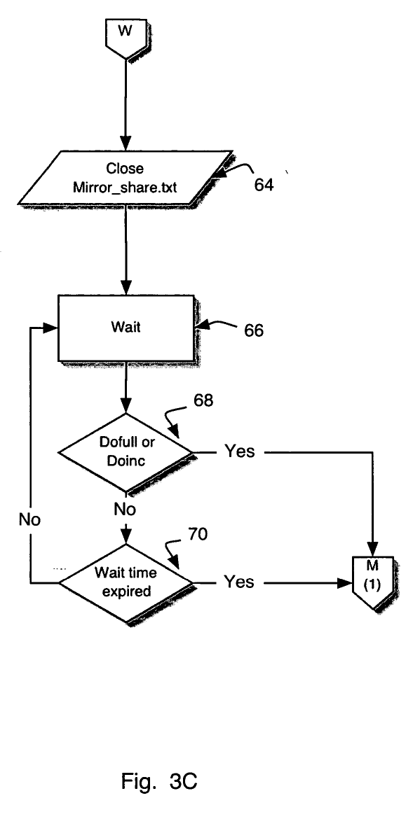

In accordance with a preferred implementation as shown in FIG. 2, the backup software 30 consists of four software modules: Mirror 32, PChost 34, Mirror_Share 36, and Mirror_lib 38. A HostIP database 39 is also shown. The functionality of these modules will be further described independent of any particular programming language that might be employed, as one skilled in the art will understand how to implement the principles of the invention in any programming language, for example C, C++, Perl script, etc. The four modules function generally as follows:

Mirror 32: This file contains the main backup routine executable. It controls copy and backup commands, polling of client devices 18, and checking for new or updated data on each client device 18.

PChosts 34: This routine is responsible for updating IP addresses for all client devices 18 connected to the network 14, so that if DHCP changes an IP address of any client device 18, the backup software 30 will be able to find the correct device 18 as specified in the Mirror_Share 36 file, to be further described. This module executes in parallel with the Mirror module.

Mirror_lib 38: in accordance with a preferred script implementation, this routine supports functions and global variable definitions for the Mirror and PChosts modules. It will be recognized that this routine might be combined with the others depending upon the programming language employed.

Mirror_Share 36: This is a text file for specifying the particular client devices 18 that will be backed up. Each line in this file specifies a client device 18 (e.g. PC, Mac, laptop), and a directory on that device 18 to be backed up to the server 12.

Each module will now be described as implemented in a preferred embodiment of the invention.

Mirror_Share 36

An entry in the Mirror_Share 36 text file is specified in the following manner:

//pcname/folder_name userid%passwd subfolder Where:

Pcname—indicates the name of the client device 18 on the network 14 that is to be backed up.

Folder_name—the name of the top level directory on the client device “pcname” under which all data will be backed up.

Userid%passwd—logon userid and password information, if required. This information is not necessarily required by PCs, but is required by current Macintoshes. This parameter may be null if not needed.

Subfolder—the name of the subdirectory under the Folder_name directory to back up. May be null. Example entries in the Mirror_Share file follow: //pc1/my documents/none none
backs up all contents of “my documents” folder on client device 18 named pc1. //pc1/work1/none none
backs up all contents of folder “work1” on pc1. //pc2/work1/none copy_this
backs up all contents of “work1/copy_this” folder on pc2. Only the upper level work1 folder needs to be shared on the network by pc2 for this operation. //macpc/joes_toplevel joe%joes_passwd Documents/work
backs up the “documents/work” folder for Joe's account on a Macintosh. Joe's userid and password are required to establish a connection between the server and the Macintosh.

As was previously mentioned, a user of a client device 18 may desire to force a full or incremental backup at any given time. To do so, the user creates a file of a predetermined name, for example “dofull” for full backup or “doinc” for incremental backup, in the top level folder that requires backup. The handling of these files is further set forth in the description of the Mirror 32 module.

Mirror 32

Generally, the Mirror 32 module loops on a sequence of checking each folder on the network that is specified in the Mirror_Share file. If the folder has not been copied yet, or if the user has created the “dofull” file as previously described, a full copy is done on that folder. If a full copy is not performed, only files in the specified folder that have been added or updated will be copied since the last loop of the program. After processing all entries in Mirror_Share, the program will wait for a period of time specified in Mirror_lib, for example five minutes, in order to conserve network bandwidth. This period of time may be set by an administrator based on system design requirements.

During the wait period, the Mirror 32 module checks all specified top-level folders to see if any users have created the dofull or doinc files. If so, the wait is aborted and a new copy loop is executed to get the data.

More particularly, referring to FIG. 3, the Mirror 32 module operates in accordance with the following steps.

First, the Mirror 32 module opens the Mirror_Share file (step 40) and reads the next entry from the list (step 42). The Mirror 32 module then checks to see if this entry is the last entry in the list (step 44), If not, the Mirror 32 module checks the syntax and contents of the entry to ascertain whether the entry is valid (step 46). If the entry is invalid, the Mirror module ignores the invalid entry and returns to step 42 to read the next entry in the list. If the entry is valid, the Mirror module proceeds to parse the pcname and share name from the entry (step 48). Once having completed this, the Mirror module checks to see if the client device specified in the entry is present on the network (step 50). If the named client is not present on the network, and the Mirror module returns to step 42 to read the next entry from the list.

Once the Mirror 32 module has parsed a valid entry and found the corresponding client device 18 to be on the network, the Mirror 32 module proceeds to step 52 to ascertain whether a full copy of the directory (as referred to as a folder) associated with the parsed share name should be done. A full copy will be done if the share name folder has not been copied before, and a full copy will be done if the do_full file exists at the top level of the shared folder (step 54). Otherwise, an incremental copy will be done (step 56). An incremental copy will copy only files that have been added or changed in the share name folder. The Mirror 32 module proceeds to execute the copy (step 57). Meanwhile, the Mirror 32 module continues to query the pcname client device 18 to make sure it is still on the network (step 58). If the device leaves the network during a copy, the Mirror 32 module marks the folder for a full copy when the device returns to the network (step 60). According to an alternate method, the Mirror 32 module could keep track of the state of the share name folder in persistent memory as it is copying, and then, if the pcname device leaves the network, the Mirror 32 module could resume an incremental copy where it left off.

If the client device does not leave the network (step 58), the Mirror 32 module continues to copy files until it is done (step 62). When finished, the Mirror 32 module proceeds back to step 42 to read the next entry and repeat the aforementioned process.

Once the Mirror 32 module ascertains that it has reached the end of the list (step 44), it closes the Mirror_share file (step 64) and enters a wait period (step 66). This wait period will vary based on network environment and system design constraints. A value in the minutes range, for example 5 minutes, is effective for preserving network bandwidth.

During the wait period, the Mirror module monitors the client devices 18 on the network to see if do_full or do_inc files have been created in any of their top level specified folders (step 68). If so, the Mirror module “wakes up” and proceeds back to step 40. If not, the mirror module waits until the wait time has expired (step 70), and then returns back to step 40.

PChost 34

The PChost module 34 provides the server 12 with the IP addresses of the names of the client devices on the network 14. In environments where there is a DNS (domain name server) on the network, the PChost module would not necessarily be required. However, the invention contemplates environments where name translation must be provided. Generally, the PChost 34 module loops through a sequence of checking each client device 18 on the network that is specified in Mirror_Share 36. If a client device 18 is on the network but does not have an IP address specified in the file the PChost 34 module updates the database with the new IP address. If any client's IP address has changed, the PChost 34 module will update the database to reflect the new address. Between loops, PChost waits an amount of time specified in the Mirror_lib module. A 10-20 second range is advantageous so that IP address information does not get stale for the Mirror 32 module.

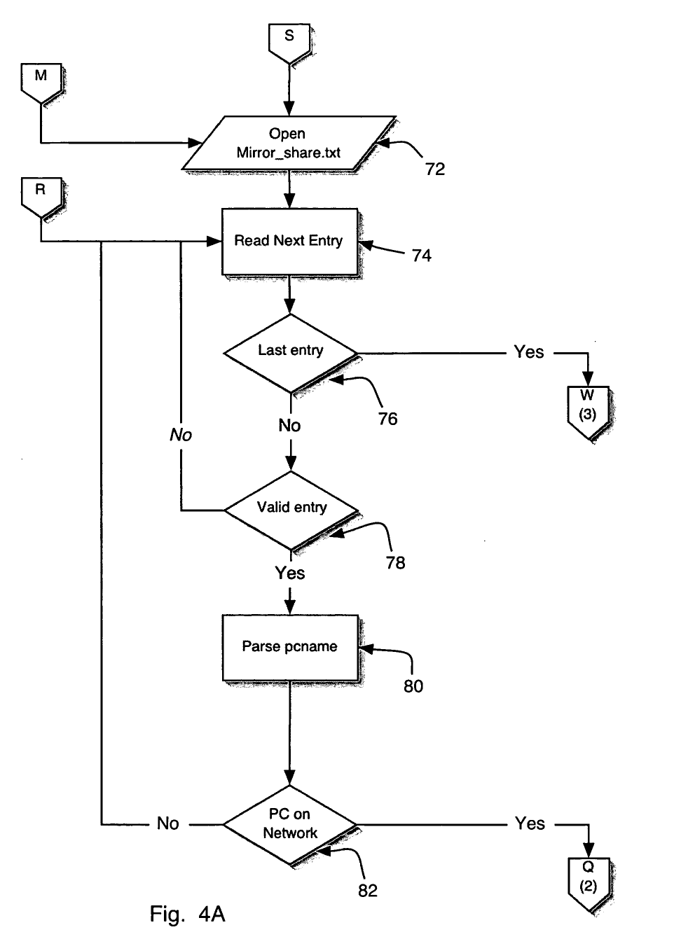

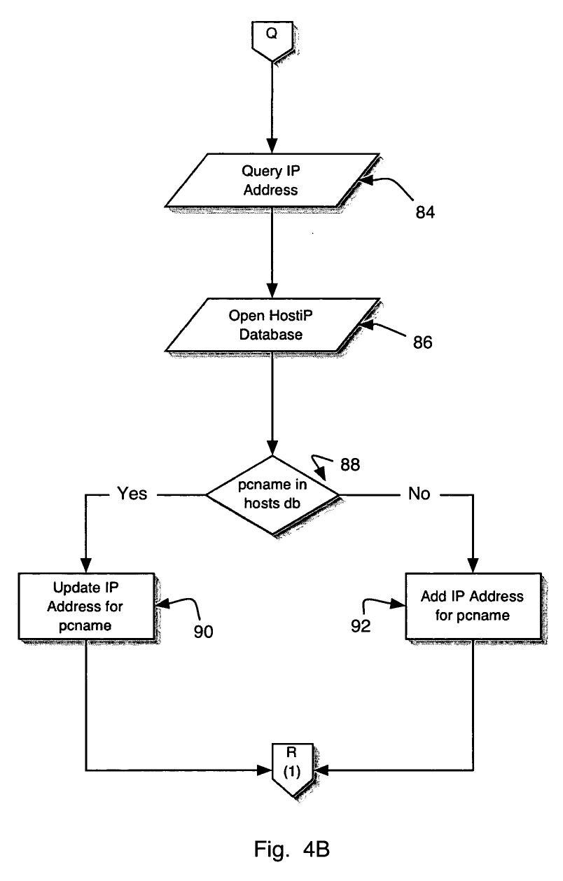

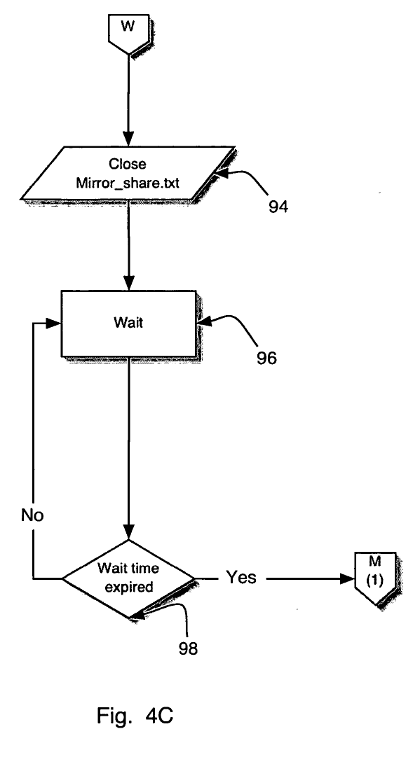

The operation of the PChost 34 module is shown in FIG. 4. PChost 34 first opens the Mirror_Share 36 file (step 72) and reads the next entry in the list (step 74). If this is not the last entry in the Mirror_Share 36 file (step 76), the PChost 34 module checks to see if the entry is valid (step 78). If it is not valid, the PChost 34 module ignores the entry and proceeds to the next entry in the list (step 74). If the entry is valid, the PChost 34 module proceeds to parse the entry for the pcname (step 80). The PChost 34 module then checks to see if the client device pcname is present on the network (step 82). If not, the PChost 34 module proceeds to read the next entry in the Mirror_Share 36 file (step 74).

If the pcname client is present on the network, the PChost 34 module queries the pcname client for its IP address (step 84). The PChost module then opens a HostIP database (step 86). The PChost 34 module then checks to see if the pcname client is already present in the hostIP database (step 88). If so, the pcname client's corresponding IP address is updated (step 90). If not, the IP address is added for the pcname client (92). The PChost 34 module then proceeds to read the next entry in the Mirror_Share file (step 74) until the last entry is reached.

When the last entry is reached, the PChost module closes the Mirror_share file (step 94) and waits for a predetermined time as set in the mirror_lib file (step 96). Once the wait time expires (step 98), the PChost module starts again from the top of the Mirror_share file (step 72).

Preferrably, the server 12 periodically copies all the data it has stored for each client device to a storage device such as a tape 16, or disk drive or CD 17, or the like for long term storage. This operation can occur once per day, or more or less frequently as needed.

Client Side Operation

Client devices 18, such as PCs and Macintoshes, have a very simple flow because most of the backup functionality is handled on the server side. The client devices 18 require no special software for the backup process to work. However, as previously mentioned, client devices do have the option of forcing a full or partial backup if desired. To request an incremental backup, a user creates a file named “doinc” in the top level folder of the folders to be backed up. The Mirror 32 module recognizes the existence of this file as previously described, and starts an incremental copy within seconds. When the copy is complete, the Mirror module deletes the doinc file. To request a full backup, the user creates a file named “dofull” in the top level folder of the folders to be backed up. The Mirror 32 module recognizes the existence of this file as previously described, and starts a full copy within seconds. When the copy is complete, the Mirror module deletes the dofull file. The actual names of the doinc and dofull files are arbitrary.

In accordance with an alternate aspect of the invention, the Mirror 32 module could gather the names of all computers currently connected to the network, rather than just those specified in Mirror_Share, and perform backup on all of them. Or, the Mirror module could gather all names of computers on the network and notify an administrator of any computer that does not exist in the Mirror_Share file, as a security measure.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the invention. Further, although aspects of the present invention have been described herein in the context of several particular implementations in particular environments for particular purposes, those of ordinary skill in the art will recognize that its usefulness is not limited thereto and that the present invention can be beneficially implemented in any number of environments for any number of purposes. For example, though backups for PCs and laptops has been described, the MirrorPC software could also be used to back up handheld devices such as PDAs, cell phones, and other wireless devices.

I claim:

1. A program product for operation in a computing environment wherein at least one server is coupled to one or more client computing devices via a network, the program product comprising a computer readable medium having embodied therein a computer program for storing data, the computer program comprising:
logic for causing files at predetermined locations on the client devices to be stored in storage coupled to the server, wherein all said logic resides on and is executed by the server.

2. The program product of claim 1 wherein a mirror file residing on the server includes the name of each client device and the name of the predetermined location on each client device for which data should be stored.

3. The program product of claim 2 wherein the logic for causing comprises logic for copying the files at the predetermined locations on the client devices to the server, the logic for copying referring to the mirror file to access the files to be copied.

4. The program product of claim 3 wherein the logic for causing further comprises logic for ascertaining, for each predetermined location, whether data has been copied from the predetermined location before, and if data has been copied from the predetermined location before, the logic for copying copies only data that is new or has been updated, and if data has not been copied from the predetermined location before, the logic for copying copies all the data from the predetermined location.

5. The program product of claim 4 wherein the client devices are transiently connected to the network.

6. A program product for operation in a computing environment wherein at least one server is coupled to one or more client computing devices via a network, the program product comprising a computer readable medium having embodied therein a computer program for storing data, the computer program comprising:
logic for causing files at predetermined locations on the client devices to be stored in storage coupled to the server, wherein all said logic resides on and is executed by the server, the logic for causing comprising:
a mirror file including the name of each client device and the name of the predetermined location on each client device from which data should be copied;
logic for copying the files at the predetermined locations on the client devices to to the server, the logic for copying referring to the mirror file to access the files to be copied.

7. The program product of claim 6 wherein the logic for causing further comprises logic for ascertaining, for each predetermined location, whether data has been copied from the predetermined location before, and if data has been copied from the predetermined location before, the logic for copying copies only data that is new or has been updated, and if data has not been copied from the predetermined location before, the logic for copying copies all the data from the predetermined location.

9. The program product of claim 8 wherein the client devices are transiently connected to the network.

10. A method for operation in a computing environment wherein at least one server is coupled to one or more client computing devices via a network, the method causing files at predetermined locations on the client devices to be stored in storage coupled to the server, the method comprising the steps of:
providing a mirror file including the name of the predetermined location on each client device from which data should be copied;
copying by the server the files at the predetermined locations on the client devices to the server by referring to the mirror file to access the files at the predetermined locations.

11. The method of claim 10 further comprising the step of ascertaining, for each predetermined location, whether data has been copied from the predetermined location before, and if data has been copied from the predetermined location before, the step of copying copies only data that is new or has been updated, and if data has not been copied from the predetermined location before, the step of copying copies all the data from the predetermined location.
